(19) United States
(12) Patent Application Publication
(10) Pub. No.: US 2011/0264327 A1
(43) Pub. Date: Oct. 27, 2011

(54) VEHICLE CONTROL DEVICE

(75) Inventor: Koji Nakai, Shizuoka (JP)

(73) Assignee: TOYOTA JIDOSHA KABUSHIKI KAISHA, Toyota-shi (JP)

(21) Appl. No.: 13/054,133

(22) PCT Filed: Jan. 18, 2010
(86) PCT No.: PCT/JP2010/050490

§ 371 Date: Jan. 14, 2011

(51) Int. Cl. B62D 6/00

(52) U.S. Cl. 701/41

(57) ABSTRACT

A vehicle control device capable of improving the reliability related to vehicle control is provided. The vehicle control device which controls a vehicle along the target trajectory includes a target trajectory setting section which sets the target trajectory of the vehicle. A clothoid section setting section sets a clothoid section with a fixed curvature change rate of the target trajectory. An elapsed time calculating section calculates the time elapsed after the vehicle enters the clothoid section. A vehicle control operation section calculates a tire angle command value, which is used for steering control of the vehicle, on the basis of the target trajectory set by the target trajectory setting section, which performs vehicle control in the clothoid section on the basis of the time elapsed calculated by the elapsed time calculating section, and the time elapsed calculated by the elapsed time calculating section.

### TECHNICAL FIELD

The present invention relates to a vehicle control device which controls a vehicle along the target trajectory.

### BACKGROUND ART

Conventionally, as a device which calculates a vehicle travel plan including the target trajectory, a device which calculates a travel plan by stratifying it into a high level plan and a low level plan is known (refer to Patent Literature 1). In the device disclosed in Patent Literature 1, the high level plan is calculated according to the vehicle travel plan while the low level plan is calculated according to a changed situation in the surrounding environment. Accordingly, the calculation of a travel plan capable of smoothly coping with a changed situation in the surrounding environment while meeting the vehicle travel plan is realized.

Citation List

### Patent Literature

Patent Literature 1: Japanese Unexamined Patent Application Publication No. 2008-129804

### SUMMARY OF INVENTION

### Technical Problem

However, a road along which a vehicle travels is generally designed by the combination of a straight line, an arc curve with fixed curvature, and a clothoid curve with a fixed curvature change rate. For this reason, the target trajectory of the vehicle in the travel plan is also mainly formed by a straight line, an arc curve, and a clothoid curve. However, a technique of making a vehicle travel along the clothoid curve of the target trajectory has not yet been studied sufficiently. This was a cause of reduction in the reliability related to vehicle control.

Therefore, it is an object of the present invention to provide a vehicle control device capable of improving the reliability related to vehicle control by calculating the tire angle command value, which is used for steering control of a vehicle, on the basis of the target trajectory and the time elapsed after the vehicle enters a clothoid section with a fixed curvature change rate.

### Solution to Problem

The present invention is a vehicle control device which controls a vehicle along a target trajectory and is characterized in that it includes: a target trajectory setting unit that sets the target trajectory of the vehicle; a clothoid section setting unit that sets a clothoid section with a fixed curvature change rate of the target trajectory set by the target trajectory setting unit; an elapsed time calculating unit that calculates the time elapsed after the vehicle enters the clothoid section; and a tire angle command value calculating unit that calculates a tire angle command value, which is used for steering control of the vehicle, on the basis of the target trajectory set by the target trajectory setting unit and the time elapsed calculated by the elapsed time calculating unit.

According to the vehicle control device related to the present invention, vehicle control, in which the disorder of transitional steering control occurring when a vehicle enters from a section without curvature change, such as a straight-line section, to the clothoid section where the curvature change is taken into consideration, can be realized by calculating the tire angle command value on the basis of the target trajectory and the time elapsed after the vehicle enters the clothoid section. Therefore, according to this vehicle control device, since it becomes possible to appropriately suppress the disorder of transitional steering control when entering the clothoid section, the reliability related to vehicle control can be improved.

In the vehicle control device related to the present invention, it is preferable to further include a slip angle detecting unit that detects a slip angle of the vehicle and a lateral force calculating unit that calculates a lateral force applied to the vehicle on the basis of the slip angle detected by the slip angle detecting unit, and it is preferable that the lateral force calculating unit calculates the lateral force by a convergence operation using a characteristic of the lateral force with respect to the slip angle in the vehicle and the tire angle command value calculating unit calculates the tire angle command value on the basis of the lateral force calculated by the lateral force calculating unit.

In this case, the lateral force can be calculated more precisely, compared with the conventional method of calculating the lateral force linearly from the slip angle. Therefore, according to this vehicle control device, it is possible to improve the calculation precision of the tire angle command value on the basis of the lateral force calculated with high precision.

Moreover, in the vehicle control device related to the present invention, it is preferable to further include a clothoid section map storage unit that stores a map for a clothoid section in which a combination of curvature and curvature change rate in the clothoid section is associated with the tire angle command value, and it is preferable that the tire angle command value calculating unit calculates the tire angle command value using the map for a clothoid section.

Thus, it becomes possible to reduce the operation amount of vehicle control in the clothoid section by performing the vehicle control using the map for a clothoid section. In addition, by improving the precision of the map for a clothoid section, it is possible to improve the reliability of vehicle control in the clothoid section.

Moreover, in the vehicle control device related to the present invention, it is preferable to further include an arc section setting unit that sets an arc section with fixed curvature of the target trajectory and a map storage unit for an arc section that stores a map for an arc section in which the curvature in the arc section is associated with the tire angle command value, and it is preferable that the tire angle command value calculating unit calculates the tire angle command value using the map for an arc section.

Thus, it becomes possible to reduce the operation amount of vehicle control in the arc section by performing the vehicle control using the map for an arc section. In addition, by improving the precision of the map for an arc section, it is possible to improve the reliability of vehicle control in the arc section.

Moreover, in the vehicle control device related to the present invention, it is preferable that the tire angle command value calculating unit calculates the tire angle command value using the following expression (1).

$$\begin{matrix}[ Expression 1 ] & \\ {δ}_{T} = \frac{V}{{C}_{1}} \cdot κ - \frac{V}{{C}_{1}} \cdot \frac{{C}_{2} \cdot ( 1 - {e}^{{c}_{6} \cdot t} )}{{C}_{1} - {C}_{2} \cdot {C}_{6} \cdot {e}^{{c}_{6} \cdot t}} d κ & ( 1 )\end{matrix}$$

In the expression (1), δT, V, κ, dκ, t, C1, C2, and C6 are a tire angle command value, a vehicle speed of a vehicle, curvature of the target trajectory, a curvature change rate of the target trajectory, the time elapsed, a coefficient expressed by the following expression (2), a coefficient expressed by the following expression (3), and a coefficient expressed by the following expression (4), respectively.

$$\begin{matrix}[ Expression 2 ] & \\ {C}_{1} = \frac{V}{( 1 - \frac{m}{{L}^{2}} \frac{( {K}_{f} {l}_{f} - {K}_{r} {l}_{r} )}{{K}_{f} {K}_{r}} {V}^{2} ) \cdot L} & ( 2 ) \\ {C}_{2} = \frac{\begin{matrix}- ( 1 + \frac{1}{m {V}^{2}} ( {K}_{f} {l}_{f} - {K}_{r} {l}_{r} ) ) V + \\ \frac{{K}_{f}}{m V} ( 1 - \frac{m}{{L}^{2}} \frac{( {K}_{f} {l}_{f} - {K}_{r} {l}_{r} )}{{K}_{f} {K}_{r}} {V}^{2} ) \cdot L\end{matrix}}{( \frac{( {K}_{f} + {K}_{r} )}{m V} ) ( 1 - \frac{m}{{L}^{2}} \frac{( {K}_{f} {l}_{f} - {K}_{r} {l}_{r} )}{{K}_{f} {K}_{r}} {V}^{2} ) \cdot L} & ( 3 ) \\ {C}_{6} = - \frac{( {K}_{f} + {K}_{r} )}{m V} & ( 4 )\end{matrix}$$

In the expressions (2) to (4), m, L, lf, lr, Kf, and Kr are the weight of a vehicle, a wheel base of a vehicle, a distance between a front axle of a vehicle and the center of gravity of the vehicle, a distance between a rear axle of a vehicle and the center of gravity of the vehicle, a lateral force of a front wheel of a vehicle, and a lateral force of a rear wheel of a vehicle, respectively.

According to this vehicle control device, calculation of the tire angle command value δT capable of suppressing the disorder of transitional steering control can be realized by using the expression (1), which uses the elapsed time t, in consideration of the disorder of transitional steering control occurring when the vehicle enters from a section without curvature change, such as a straight-line section, to the clothoid section where the curvature changes. Therefore, according to the vehicle control device, since it becomes possible to appropriately suppress the disorder of transitional steering control when entering the clothoid section, the reliability related to vehicle control can be improved.

### Advantageous Effects of Invention

According to the present invention, the reliability related to vehicle control can be improved.

### BRIEF DESCRIPTION OF DRAWINGS

FIG. 1 is a block diagram showing a vehicle control device related to a first embodiment.

FIG. 2 is a view showing a method of calculating the tire angle command value related to the first embodiment.

FIG. 3 is a flow chart showing the process of an ECU of the vehicle control device related to the first embodiment.

FIG. 4 is a view showing the calculation result of the tire angle command value related to the first embodiment.

FIG. 5 is a block diagram showing a vehicle control device related to a second embodiment.

FIG. 6 is a view showing a method of calculating the tire angle command value related to the second embodiment.

FIG. 7 is a view for explaining the procedure of creating a map for an arc section.

FIG. 8 is a view showing the calculation result of the tire angle command value related to the second embodiment.

FIG. 9 is a flow chart showing the process of an ECU of the vehicle control device related to the second embodiment.

FIG. 10 is a block diagram showing a vehicle control device related to a third embodiment.

FIG. 11 is a view showing a method of calculating the tire angle command value related to the third embodiment.

FIG. 12 is a view for explaining the procedure of creating a map for a clothoid section.

FIG. 13 is a view showing the calculation result of the tire angle command value related to the third embodiment.

FIG. 14 is a flow chart showing the process of an ECU of the vehicle control device related to the third embodiment.

### DESCRIPTION OF EMBODIMENTS

Hereinafter, preferred embodiments of a vehicle control device related to the present invention will be described in detail with reference to the drawings. In addition, the same sections are denoted by the same reference numerals, and a repeated explanation will be omitted.

### First embodiment

A vehicle control device 1 related to a first embodiment sets a target trajectory from the current location of a vehicle to the destination and also performs vehicle control along this target trajectory. The vehicle control device 1 calculates a control command value, which is used for future vehicle control, on the basis of the set target trajectory. As the control command value, there are a tire angle command value for controlling the tire angle of a vehicle, an acceleration command value or a deceleration command value, and the like.

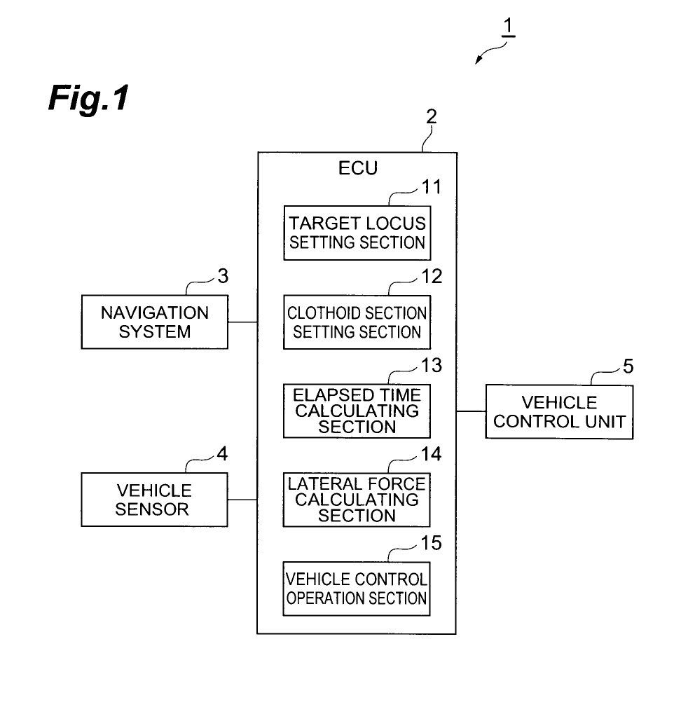

As shown in FIG. 1, the vehicle control device 1 includes an ECU [Electric Control Unit] 2 which performs overall control of the device. The ECU 2 is an electric control unit including a CPU [Central Processing Unit] which performs arithmetic processing, a ROM [Read Only Memory] and a RAM [Random Access Memory] serving as a storage section, an input signal circuit, an output signal circuit, a power supply circuit, and the like. The ECU 2 is electrically connected to a navigation system 3, a vehicle sensor 4, and a vehicle control unit 5.

The navigation system 3 measures the absolute position of a vehicle on the surface of the earth by a GPS [Global Positioning System]. The absolute position of the vehicle on the surface of the earth measured by the GPS is combined with the map information separately stored. Thus, the navigation system 3 specifies the position of the vehicle on the map. The navigation system 3 transmits the specified position of the vehicle to the ECU 2 as a position signal. In addition, when the destination of a vehicle is input from a driver, the navigation system 3 transmits the input destination to the ECU 2 as a destination signal.

The vehicle sensor 4 is a device which detects a traveling state of a vehicle, such as a speed, acceleration, a yaw rate, a tire angle, and a slip angle of the vehicle. Specifically, the vehicle sensor 4 is formed by various kinds of sensors, such as a vehicle speed sensor or a slip angle sensor. The vehicle sensor 4 functions on a slip angle detecting unit described in the appended claims. The vehicle sensor 4 transmits the detected traveling state of the vehicle to the ECU 2 as a traveling state signal.

The vehicle control unit 5 controls a vehicle according to the control signal transmitted from the ECU 2. The vehicle control unit 5 controls traveling driving, braking operation, steering operation, and the like of a vehicle. The vehicle control unit 5 is configured to include an ECU for traveling driving that controls an actuator which adjusts the opening ratio of a throttle valve of an engine, an ECU for braking that controls a brake actuator which adjusts the hydraulic pressure of the brake, an ECU for steering that controls a steering actuator which gives steering torque, and the like.

The ECU 2 has a target trajectory setting section 11, a clothoid section setting section 12, an elapsed time calculating section 13, a lateral force calculating section 14, and a vehicle control operation section 15.

The target trajectory setting section 11 sets a target trajectory from the current position of a vehicle to the destination. Specifically, the target trajectory setting section 11 recognizes the position of the vehicle and the destination on the basis of the position signal and the destination signal transmitted from the navigation system 3. The target trajectory setting section 11 sets a target trajectory from the current position of the vehicle to the destination by referring to the map information, which is separately stored, together with the position of the vehicle and the destination. The target trajectory is a future trajectory along which the vehicle will travel to reach the destination. The target trajectory is formed by many target points which are set so as to continue at predetermined intervals, and information regarding the curvature and the curvature change rate of the target trajectory is set at each target point. The target trajectory setting section 11 functions as a target trajectory setting unit described in the appended claims.

The clothoid section setting section 12 sets, as a clothoid section, a section with a fixed curvature change rate of the target trajectory set by the target trajectory setting section 11. The clothoid section setting section 12 functions as a clothoid section setting unit described in the appended claims.

The elapsed time calculating section 13 calculates the time elapsed after a vehicle enters the clothoid section. For example, when a vehicle has entered a region far from the starting point of the clothoid section by a predetermined distance, the elapsed time calculating section 13 determines that calculation regarding the time elapsed is necessary for vehicle control in the future clothoid section. If it is determined that calculation regarding the time elapsed is necessary, the elapsed time calculating section 13 recognizes the current traveling state of the vehicle on the basis of the traveling state signal transmitted from the vehicle sensor 4. The elapsed time calculating section 13 calculates a future value of the time elapsed at each target point, which forms the clothoid section, on the basis of the recognized current traveling state of the vehicle. The elapsed time calculating section 13 functions as an elapsed time calculating unit described in the appended claims.

The lateral force calculating section 14 calculates the lateral force of a vehicle. Specifically, the lateral force calculating section 14 recognizes the slip angle of a vehicle on the basis of the traveling state signal transmitted from the vehicle sensor 4. The lateral force calculating section 14 calculates the future value of the lateral force of the vehicle by performing a convergence operation, which uses the characteristic of the lateral force with respect to the slip angle in the vehicle, using the recognized slip angle or the slip angle predicted in the future. The lateral force calculating section 14 calculates the lateral force of a front wheel and the lateral force of a rear wheel when a vehicle is considered as a so-called two-wheeled model in which the width direction of a vehicle is neglected. The lateral force calculating section 14 functions as a lateral force calculating unit described in the appended claims.

The vehicle control operation section 15 performs vehicle control by transmitting a control signal to the vehicle control unit 5. The vehicle control operation section 15 functions as a tire angle command value calculating unit described in the appended claims. The vehicle control operation section 15 calculates a control command value for controlling a vehicle on the basis of the position signal transmitted from the navigation system 3, the traveling state signal transmitted from the vehicle sensor 4, the lateral force of the vehicle, and the target trajectory. The vehicle control operation section 15 transmits the calculated control command value to the vehicle control unit 5 as a control signal.

Here, calculation of a tire angle command value, among calculation of control command values in the vehicle control operation section 15, will be described in detail.

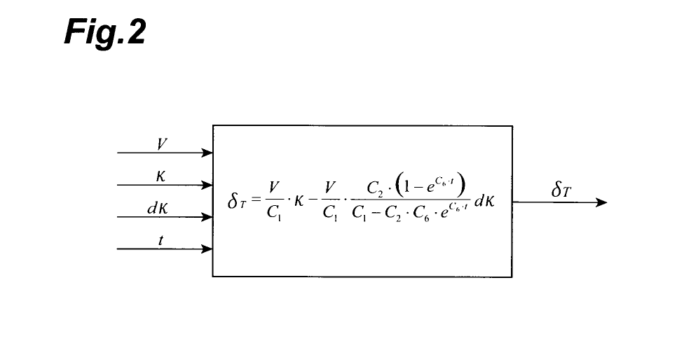

FIG. 2 is a view for explaining the calculation of a tire angle command value related to the first embodiment. In FIG. 2, V, κ, dκ, t, and δT indicate a vehicle speed (m/s), the curvature (1/m) of the target trajectory, a curvature change rate (1//m/s) of the target trajectory, the time elapsed (s) after a vehicle enters a clothoid section, and a tire angle command value (rad), respectively. As shown in FIG. 2, the vehicle control operation section 15 calculates the tire angle command value δT at any point on the target trajectory by substituting vehicle speed V, the curvature κ and the curvature change rate dκ of the target trajectory, and the elapsed time t after a vehicle enters a clothoid section into the following expression (1). As the vehicle speed V, for example, a future value calculated on the basis of a current vehicle speed by the conventional method is used.

$$\begin{matrix}[ Expression 1 ] & \\ {δ}_{T} = \frac{V}{{C}_{1}} \cdot κ - \frac{V}{{C}_{1}} \cdot \frac{{C}_{2} \cdot ( 1 - {e}^{{c}_{6} \cdot t} )}{{C}_{1} - {C}_{2} \cdot {C}_{6} \cdot {e}^{{c}_{6} \cdot t}} d κ & ( 1 )\end{matrix}$$

In addition, C1, C2, and C6 in the above expression (1) are values calculated from the vehicle specifications and the traveling state of the vehicle, and they are expressed by the following expressions (2) to (4). Here, m, L, lf, lr, Kf, and Kr indicate vehicle weight (kg), a wheel base (m), a shortest distance (m) between the front axle of the vehicle and the center of gravity of the vehicle, a shortest distance (m) between the rear axle of the vehicle and the center of gravity of the vehicle, a lateral force (N/rad) of a front wheel when the vehicle is considered as a two-wheeled model, and a lateral force (N/rad) of a rear wheel when the vehicle is considered as a two-wheeled model, respectively. Kf and Kr are the values calculated by the lateral force calculating section 14.

$$\begin{matrix}[ Expression 2 ] & \\ {C}_{1} = \frac{V}{( 1 - \frac{m}{{L}^{2}} \frac{( {K}_{f} {l}_{f} - {K}_{r} {l}_{r} )}{{K}_{f} {K}_{r}} {V}^{2} ) \cdot L} & ( 2 ) \\ {C}_{2} = \frac{\begin{matrix}- ( 1 + \frac{1}{m {V}^{2}} ( {K}_{f} {l}_{f} - {K}_{r} {l}_{r} ) ) V + \\ \frac{{K}_{f}}{m V} ( 1 - \frac{m}{{L}^{2}} \frac{( {K}_{f} {l}_{f} - {K}_{r} {l}_{r} )}{{K}_{f} {K}_{r}} {V}^{2} ) \cdot L\end{matrix}}{( \frac{( {K}_{f} + {K}_{r} )}{m V} ) ( 1 - \frac{m}{{L}^{2}} \frac{( {K}_{f} {l}_{f} - {K}_{r} {l}_{r} )}{{K}_{f} {K}_{r}} {V}^{2} ) \cdot L} & ( 3 ) \\ {C}_{6} = - \frac{( {K}_{f} + {K}_{r} )}{m V} & ( 4 )\end{matrix}$$

The above expression (1) is created on the basis of the characteristic of the clothoid curve in which the curvature change rate is fixed. Specifically, the relational expression of the yaw rate and the tire angle and the relational expression of the slip angle and the tire angle can be established by noting that changes of the yaw rate and the slip angle in vehicle traveling along the clothoid curve where the steering speed is fixed are linear increases. Then, expression (1) is obtained by arranging the relational expression of the yaw rate and the tire angle and the relational expression of the slip angle and the tire angle using a known method.

Next, processing executed by the ECU 2 of the vehicle control device 1 related to the first embodiment will be described with reference to the drawings.

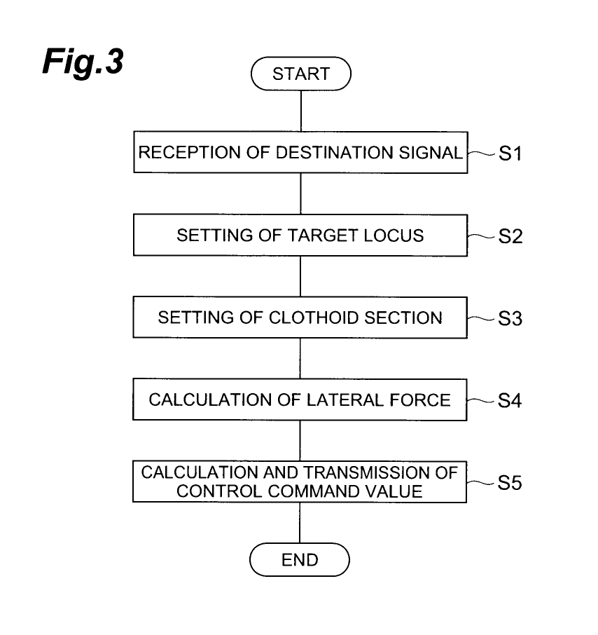

As shown in FIG. 3, first, the target trajectory setting section 11 of the ECU 2 receives a destination signal transmitted from the navigation system 3 (S1). The target trajectory setting section 11 recognizes the destination of the vehicle on the basis of the received destination signal. In addition, the target trajectory setting section 11 recognizes the current position of the vehicle on the basis of the position signal transmitted from the navigation system 3. Then, the target trajectory setting section 11 sets the target trajectory from the current position of the vehicle to the destination (S2).

After the target trajectory is set, the clothoid section setting section 12 sets, as a clothoid section, a section with the fixed curvature change rate dκ of the target trajectory (S3). Then, the lateral force calculating section 14 calculates the lateral forces Kf and Kr of the vehicle on the basis of an slip angle β included in the traveling state signal transmitted from the vehicle sensor 4 (S4).

In S5, the vehicle control operation section 15 calculates a control command value on the basis of the position signal transmitted from the navigation system 3, the traveling state signal transmitted from the vehicle sensor 4, the elapsed time t, the lateral forces Kf and Kr of the vehicle, and the target trajectory. Here, the vehicle control operation section 15 calculates the tire angle command value δT by substituting vehicle speed V, the curvature κ and the curvature change rate dκ of the target trajectory, and the elapsed time t after the vehicle enters a clothoid section into the following expression (1). The vehicle control operation section 15 transmits a control command value including the tire angle command value δT to the vehicle control unit 5 as a control signal. The vehicle control unit 5 controls the vehicle according to the control signal transmitted from the vehicle control operation section 15.

According to the vehicle control device 1 related to the first embodiment described above, vehicle control, in which the disorder of transitional steering control caused by control delay when a vehicle enters from a section without curvature change, such as a straight-line section, to the clothoid section where the curvature change is taken into consideration, can be realized by calculating the tire angle command value on the basis of the target trajectory and the elapsed time t after the vehicle enters the clothoid section. Specifically, when a vehicle enters from a section of a straight line or an arc curve with fixed curvature to the clothoid section, control delay occurs due to a sudden change in the curvature change rate dκ. Since the disorder of steering control caused by control delay decreases as the time elapses, the tire angle command value δT capable of suppressing the disorder of transitional steering control can be calculated by using the expression (1) in which the elapsed time t is used for a term for suppressing the influence by the control delay. Therefore, according to the vehicle control device 1, since it becomes possible to suppress the disorder of vehicle control when entering the clothoid section, the reliability related to vehicle control can be improved.

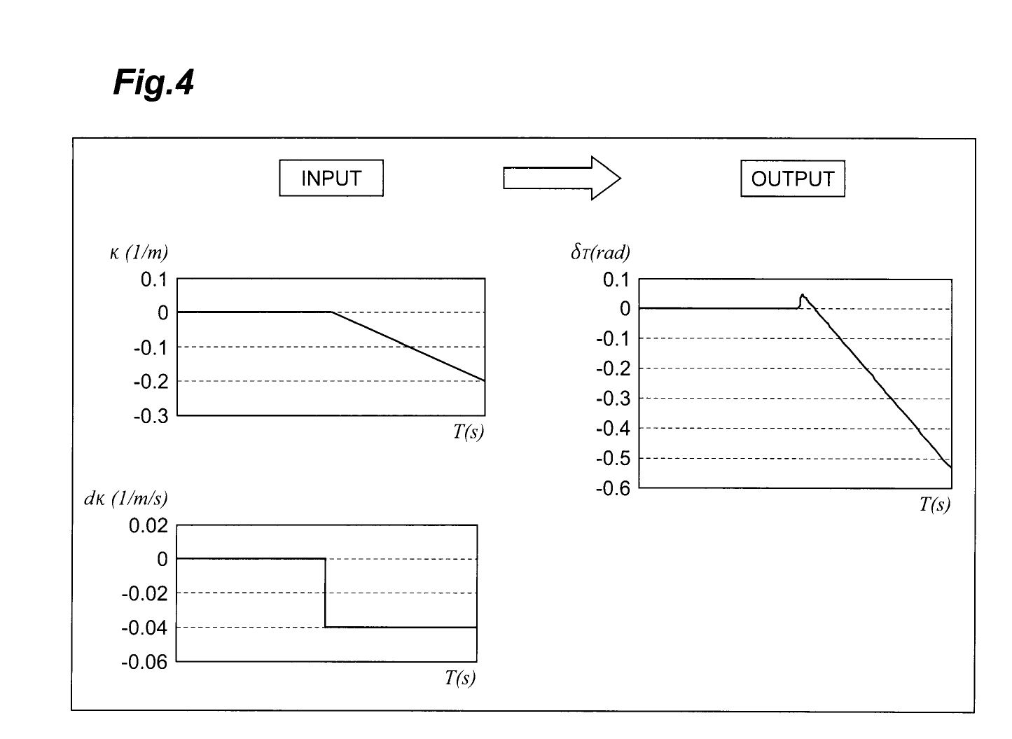

FIG. 4 is a view showing the calculation result of the tire angle command value δT using the expression (1). FIG. 4 shows changes in the curvature κ and the curvature change rate dκ and the calculation result of the tire angle command value δT when a vehicle travels from the straight-line section to the clothoid section on the target trajectory. In addition, the vehicle speed V is a fixed value, and a value corresponding to the vehicle speed V is used as the elapsed time t. As shown in FIG. 4, according to the vehicle control device 1, the tire angle command value δT is calculated using the expression (1), which uses the elapsed time t, in consideration of the disorder of transitional steering control occurring when the vehicle enters from a section without curvature change, such as a straight-line section, to the clothoid section where the curvature changes. Therefore, it is possible to appropriately suppress an influence of control delay occurring when entering the clothoid section where the curvature κ and the curvature change rate dκ largely change. Therefore, according to the vehicle control device 1, since it is possible to appropriately suppress the influence of control delay occurring when entering the clothoid section, the reliability related to vehicle control can be improved.

Moreover, in the vehicle control device 1, the tire angle command value δT is directly calculated using the expression (1). Accordingly, since the amount of storage required is small compared with the case where the tire angle command value δT is calculated using a map in which the curvature κ or the like of the target trajectory and the tire angle command value δT are associated with each other, the memory capacity can be significantly reduced. Moreover, in the vehicle control device 1, the tire angle command value δT can be analytically calculated from the expression (1). Therefore, unlike the case where the tire angle command value δT is calculated using the convergence operation by which it is not decided whether or not a solution can be acquired, a solution can be reliably calculated. This contributes to improving the reliability related to vehicle control of the vehicle control device 1.

Moreover, since the lateral forces Kf and Kr are calculated by performing the convergence operation using the characteristic of the lateral force with respect to the slip angle in a vehicle in the vehicle control device 1, the lateral forces Kf and Kr can be calculated more precisely than in the case where the lateral forces Kf and Kr are linearly calculated from the slip angles βf and βr by the conventional method. Therefore, according to the vehicle control device 1, it is possible to improve the calculation precision of the tire angle command value on the basis of the lateral forces calculated with high precision. Moreover, in the vehicle control device 1, the lateral forces Kf and Kr are calculated by the convergence operation. Accordingly, unlike the case where the lateral forces Kf and Kr are linearly calculated by the conventional method, the highly precise lateral forces Kf and Kr can be calculated under the conditions where the slip angle is large and the non-linearity of a tyre is strong accordingly. As a result, vehicle control (trace) along the target trajectory can be ensured under the conditions where values of the slip angles βf and βr are large and the non-linearity of a tyre is strong accordingly. In addition, according to the vehicle control device 1, the memory capacity can be reduced compared with the case where the lateral forces Kf and Kr are calculated using a map stored in advance.

### Second embodiment

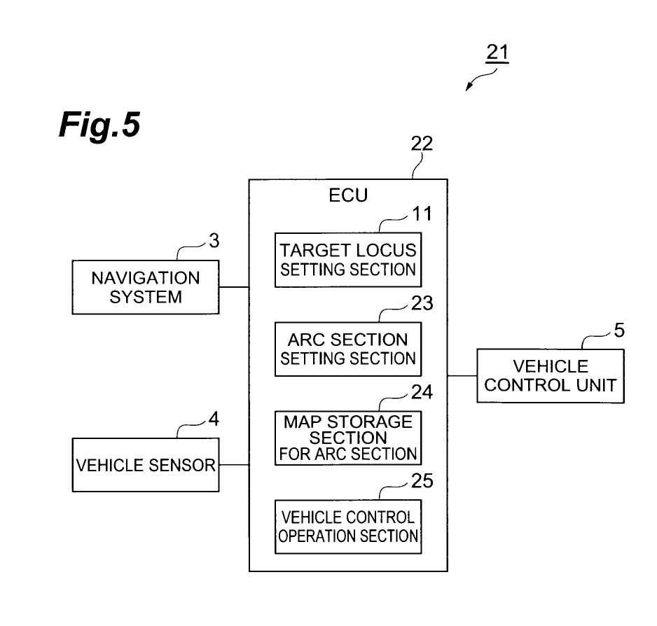

Next, a vehicle control device 21 related to a second embodiment will be described with reference to the drawings. In the vehicle control device 21 related to the second embodiment, a method of calculating the tire angle command value δT in the arc section with the fixed curvature κ of the target trajectory is different from that in the vehicle control device 1 related to the first embodiment. Specifically, as shown in FIG. 5, an ECU 22 of the vehicle control device 21 related to the second embodiment is different from the ECU 2 related to the first embodiment in that the elapsed time calculating section 13 is not provided, an arc section setting section 23 is provided instead of the clothoid section setting section 12, and a map storage section for an arc section 24 is provided, and a function of a vehicle control operation section 25 is also different.

The arc section setting section 23 of the ECU 22 sets, as an arc section, a section with the fixed curvature κ of the target trajectory set by the target trajectory setting section 11. The arc section setting section 23 functions as an arc section setting unit described in the appended claims. The map storage section for an arc section 24 stores a map for an arc section which is used in calculating the tire angle command value δT of a vehicle in the arc section. The map for an arc section is obtained by associating the curvature κ in the arc section with the tire angle command value δT. The map storage section for an arc section 24 functions as a map storage unit for an arc section described in the appended claims.

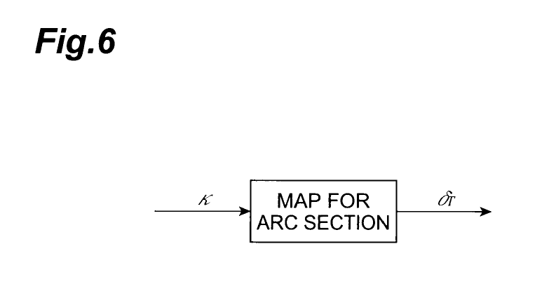

The vehicle control operation section 25 of the ECU 22 related to the second embodiment calculates the tire angle command value δT in the arc section using the map for an arc section (refer to FIG. 6). By controlling a vehicle using the tire angle command value δT obtained from the map for an arc section, traveling of the vehicle along the arc section with predetermined curvature is realized.

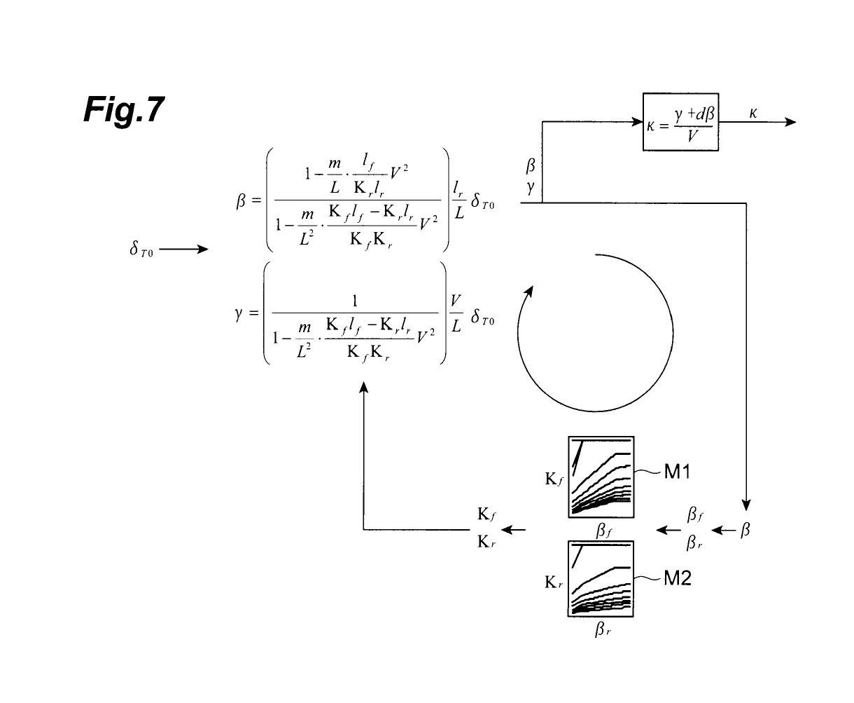

Hereinafter, the procedure of creating the map for an arc section related to the second embodiment will be described with reference to FIG. 7.

As shown in FIG. 7, the map for an arc section is created by a convergence operation using the following expressions (5) and (6). Here, δT0, β, γ, Kf, Kr, L, m, lf, and lr indicate a designation tire angle command value which designates any value, a slip angle (rad) at the center of gravity of the vehicle, a yaw rate (rad/s) of the vehicle, a lateral force (N/rad) of a front wheel when the vehicle is considered as a two-wheeled model, a lateral force (N/rad) of a rear wheel when the vehicle is considered as a two-wheeled model, a wheel base (m) of the vehicle, vehicle weight (kg), a shortest distance (m) between the front axle of the vehicle and the center of gravity of the vehicle, a shortest distance (m) between the rear axle of the vehicle and the center of gravity of the vehicle, respectively.

$$\begin{matrix}[ Expression 3 ] & \\ β = ( \frac{1 - \frac{m}{L} \cdot \frac{{l}_{f}}{{K}_{f} {l}_{r}} {V}^{2}}{1 - \frac{m}{{L}^{2}} \frac{{K}_{f} {l}_{f} - {K}_{r} {l}_{r} )}{{K}_{f} {K}_{r}} {V}^{2}} ) \frac{{l}_{r}}{L} {δ}_{T 0} & ( 5 ) \\ γ = ( \frac{1}{1 - \frac{m}{{L}^{2}} \frac{{K}_{f} {l}_{f} - {K}_{r} {l}_{r} )}{{K}_{f} {K}_{r}} {V}^{2}} ) \frac{V}{L} {δ}_{T 0} & ( 6 )\end{matrix}$$

In the above expressions (5) and (6), the vehicle weight m, the wheel base L, the shortest distance if between the front axle of the vehicle and the center of gravity of the vehicle, and the shortest distance lr between the rear axle of the vehicle and the center of gravity of the vehicle are known values derived from the vehicle specifications. Here, assuming that the designation tire angle command value δT0 and the vehicle speed V are predetermined values, expression (5) can be regarded as an expression showing the relationship between the slip angle β and the lateral forces Kf and Kr. In addition, the lateral forces Kf and Kr are calculated from the slip angle β by using map M1 and M2 created on the basis of results of actual vehicle tests. In the map M1, the slip angle βf in a front wheel is associated with the lateral force Kf applied to the front wheel. In the map M2, the slip angle βr in a rear wheel is associated with the lateral force Kr applied to the rear wheel. The slip angle βf in the front wheel and the slip angle βr in the rear wheel can be calculated from the slip angle β at the center of gravity of the vehicle by the conventional method.

By performing a convergence operation on the slip angle β using the expression (5) showing the relationship between the slip angle β and the lateral forces Kf and Kr and the maps M1 and M2 described above, the slip angle β corresponding to the combination of the predetermined designation tire angle command value δT0 and the predetermined vehicle speed V is obtained as a solution. In addition, since the lateral forces Kf and Kr are set together with the slip angle β, the yaw rate γ is calculated from expression (6). The curvature of the traveling trajectory of the vehicle which satisfies the slip angle β, the yaw rate γ, and the vehicle speed V can be expressed by the following expression (7) using the symbol κ. Here, dβ is a differential value of the slip angle β. In addition, the curvature κ corresponding to the predetermined designation tire angle command value δT0 can be obtained by calculating the curvature κ using the expression (7).

$$\begin{matrix}[ Expression 4 ] & \\ κ = \frac{γ + d β}{V} & ( 7 )\end{matrix}$$

By performing the above-described procedure for the designation tire angle command value δT0 of various values, it is possible to create a map for an arc section in which the curvature κ in the arc section and the tire angle command value δT corresponding thereto are associated with each other. In addition, a plurality of maps for arc sections can be created corresponding to the values of the vehicle speed V.

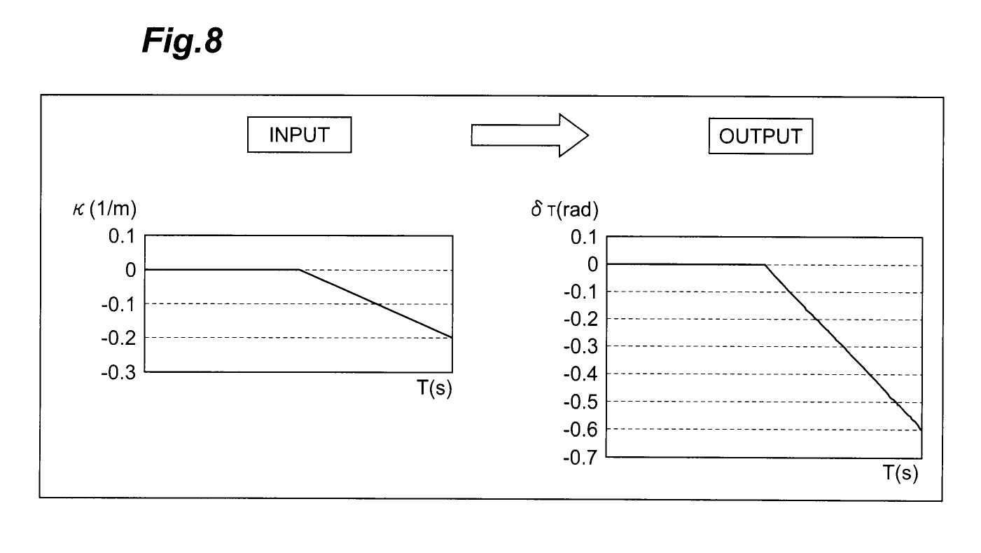

FIG. 8 is a view showing the calculation result of the tire angle command value δT related to the second embodiment in which the map for an arc section is used. FIG. 8 shows a change in the curvature κ and the calculation result of the tire angle command value δT when a vehicle travels from the straight-line section to the clothoid section on the target trajectory. In addition, the vehicle speed V is constant. As shown in FIG. 8, smooth steering control of the vehicle is realized by calculating the tire angle command value δT using the map for an arc section.

Next, processing executed by the ECU 22 of the vehicle control device 21 related to the second embodiment will be described with reference to the drawings.

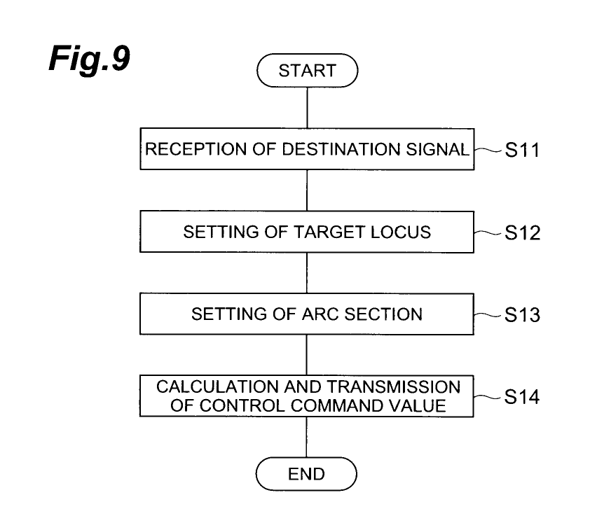

As shown in FIG. 9, first, the target trajectory setting section 11 of the ECU 22 receives a destination signal transmitted from the navigation system 3 (S11). The target trajectory setting section 11 recognizes the destination of the vehicle and the current position of the vehicle on the basis of the received destination signal and position signal. Then, the target trajectory setting section 11 sets the target trajectory from the current position of the vehicle to the destination (S12). After the target trajectory is set, the arc section setting section 23 sets, as an arc section, a section with the fixed curvature κ of the target trajectory (S13).

In S14, the vehicle control operation section 25 calculates a control command value on the basis of the position signal transmitted from the navigation system 3, the traveling state signal transmitted from the vehicle sensor 4, and the target trajectory. Here, the vehicle control operation section 25 calculates the tire angle command value δT in the arc section using the map for an arc section. The map for an arc section is changed according to the corresponding vehicle speed V. The vehicle control operation section 25 transmits a control command value including the tire angle command value δT to the vehicle control unit 5 as a control signal. The vehicle control unit 5 controls the vehicle according to the control signal transmitted from the vehicle control operation section 25.

According to the vehicle control device 21 related to the second embodiment described above, it becomes possible to reduce the operation amount of vehicle control in the arc section by performing the vehicle control using the map for an arc section. In addition, by improving the precision of the map for an arc section, it is possible to improve the reliability of vehicle control in the arc section. Moreover, in the vehicle control device 21, the map for an arc section is created by the above-described creation procedure using the maps M1 and M2 created on the basis of the results of actual vehicle tests. Accordingly, vehicle control along the target trajectory can be ensured under the conditions where the value of the slip angle β is large and the non-linearity of a tyre is strong accordingly.

### Third embodiment

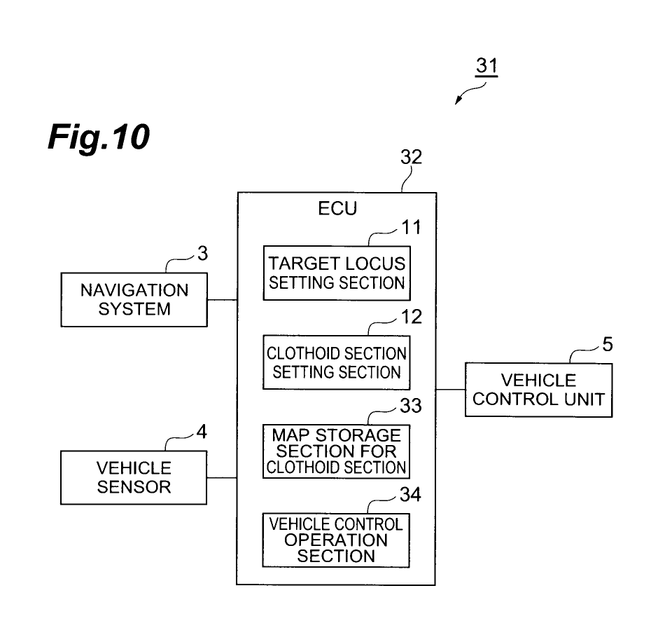

Next, a vehicle control device 31 related to a third embodiment will be described with reference to the drawings. In the vehicle control device 31 related to the third embodiment, a method of calculating the tire angle command value δT in the clothoid section is different from that in the vehicle control device 1 related to the first embodiment. Specifically, as shown in FIG. 10, an ECU 32 of the vehicle control device 31 related to the third embodiment is different from the ECU 2 related to the first embodiment in that the elapsed time calculating section 13 is not provided and a map storage section for a clothoid section 33 is provided, and a function of a vehicle control operation section 34 is also different.

The map storage section for a clothoid section 33 of the ECU 32 related to the third embodiment stores a map for a clothoid section which is used for calculation of the tire angle command value δT of the vehicle in the clothoid section. In the map for a clothoid section, a combination of the curvature κ and the curvature change rate dκ in the clothoid section is associated with the tire angle command value δT. The map storage section for a clothoid section 33 functions as a map storage unit for a clothoid section described in the appended claims.

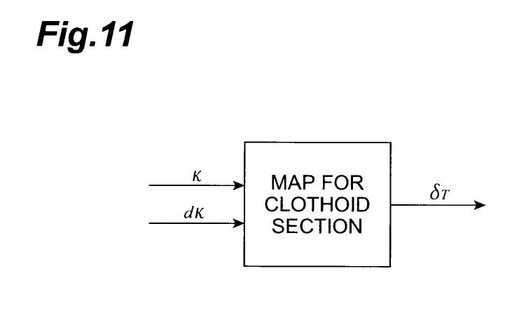

The vehicle control operation section 34 calculates the tire angle command value δT in the clothoid section using the map for a clothoid section (refer to FIG. 11). By controlling a vehicle using the tire angle command value δT obtained from the map for a clothoid section, traveling of the vehicle along the clothoid section with predetermined curvature is realized.

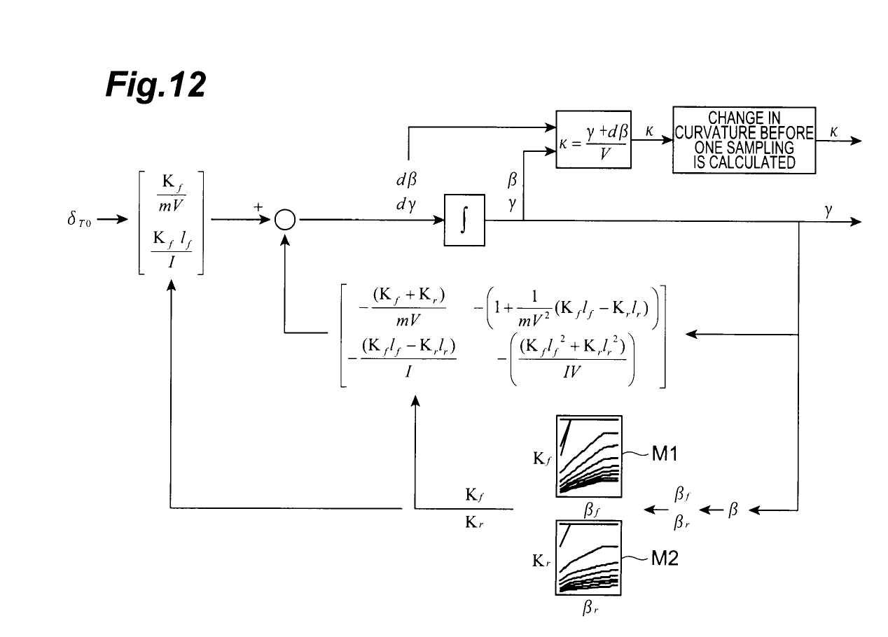

Hereinafter, the procedure of creating a map for a clothoid section related to the third embodiment will be described with reference to FIG. 12.

As shown in FIG. 12, the map for a clothoid section is created by a convergence operation using the following expressions (8) to (10). Here, I and dγ indicate a yaw moment of inertia of a vehicle and a differential value of the yaw rate of a vehicle, respectively. Since other symbols are the same as those in the cases of expressions (5) to (7) in the second embodiment, the explanation will be omitted.

$$\begin{matrix}[ Expression 5 ] & \\ [ \begin{matrix}d β \\ d γ\end{matrix} ] = [ A ] [ \begin{matrix}β \\ γ\end{matrix} ] + [ B ] {δ}_{T 0} & ( 8 ) \\ [ A ] = [ \begin{matrix}- \frac{( {K}_{f} + {K}_{r} )}{m V} & - ( 1 + \frac{1}{m {V}^{2}} ( {K}_{f} {l}_{f} - {K}_{r} {l}_{r} ) ) \\ - \frac{( {K}_{f} {l}_{f} - {K}_{r} {l}_{r} )}{I} & - ( \frac{( {K}_{f} {l}_{f}^{2} + {K}_{r} {l}_{r}^{2} )}{IV} )\end{matrix} ] & ( 9 ) \\ [ B ] = [ \begin{matrix}\frac{{K}_{f}}{m V} \\ \frac{{K}_{f} {l}_{f}}{I}\end{matrix} ] & ( 10 )\end{matrix}$$

In the above expressions (8) to (10), the yaw moment of inertia I, the vehicle weight m, the wheel base L, the shortest distance if between the front axle of the vehicle and the center of gravity of the vehicle, and the shortest distance lr between the rear axle of the vehicle and the center of gravity of the vehicle are known values derived from the vehicle specifications. Here, assuming that the designation tire angle command value δT0 and the vehicle speed V are predetermined values, expressions (8) to (10) can be regarded as secondary determinants showing the relationship among the slip angle β and the yaw rate γ, the differential value dβ of the slip angle β and the differential value dγ of the yaw rate γ, and the lateral forces Kf and Kr. In addition, by performing a convergence operation on the slip angle β using the expressions (8) to (10) and the maps M1 and M2 created on the basis of results of actual vehicle tests similar to the second embodiment, the slip angle β corresponding to the combination of any designation tire angle command value δT0 and the vehicle speed V and its differential value dβ are obtained as a solution. In addition, symbol ∫ shown in FIG. 7 indicates integration processing.

In addition, since the lateral forces Kf and Kr are set together with the slip angle β, the yaw rate γ and its differential value dγ are calculated from the expressions (8) to (10). The curvature of the traveling trajectory of the vehicle which satisfies the differential value dβ of the slip angle, the yaw rate γ, and the vehicle speed V can be expressed by the following expression (11) using the symbol κ. Thus, the curvature κ corresponding to the predetermined designation tire angle command value δT0 can be calculated.

$$\begin{matrix}[ Expression 6 ] & \\ κ = \frac{γ + d β}{V} & ( 11 )\end{matrix}$$

By performing the above-described procedure for the designation tire angle command value δT0 of various values, the value of the curvature κ corresponding to each designation tire angle command value δT0 is calculated. Moreover, by giving the value of the designation tire angle command value δT0 in various patterns, such as a linear increase, the curvature change rate dκ is calculated from value changes in the curvature κ before one sampling and the curvature κ of current calculation. Thus, it is possible to create a map for a clothoid section in which a combination of the curvature κ and the curvature change rate dκ in the clothoid section is associated with the tire angle command value δT. In addition, a plurality of maps for clothoid sections is created corresponding to the values of the vehicle speed V.

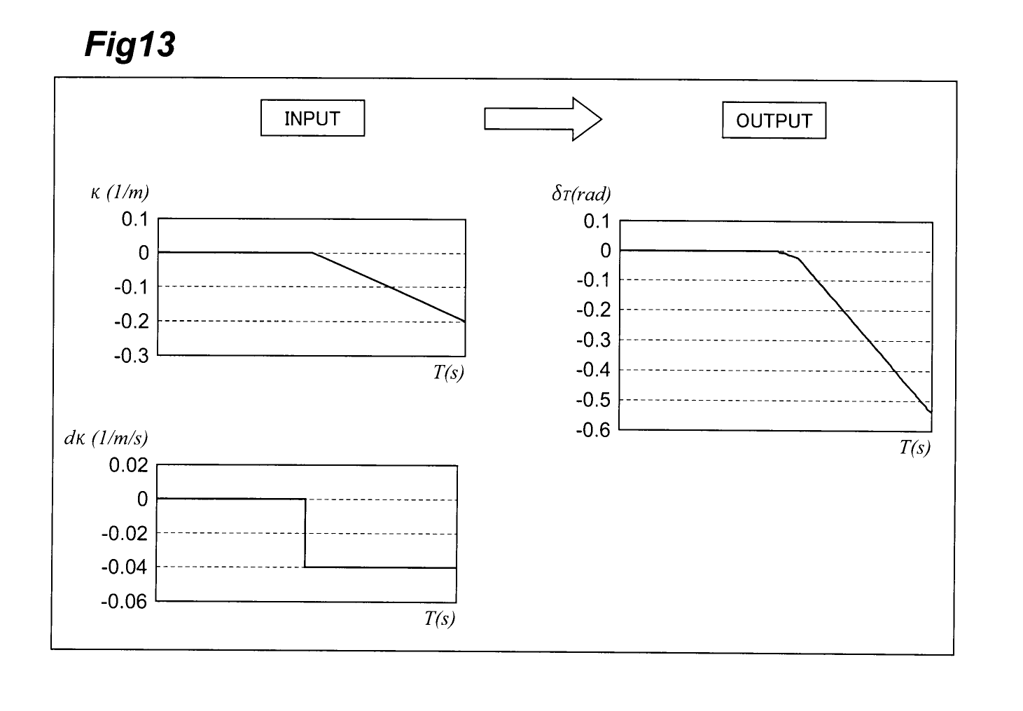

FIG. 13 is a view showing the calculation result of the tire angle command value δT related to the third embodiment in which the map for a clothoid section is used. FIG. 13 shows changes in the curvature κ and the curvature change rate dκ and the calculation result of the tire angle command value δT when a vehicle travels from the straight-line section to the clothoid section on the target trajectory. In addition, the vehicle speed V is constant. As shown in FIG. 13, smooth steering control of the vehicle in the clothoid section is realized by calculating the tire angle command value δT using the map for a clothoid section.

Next, processing executed by the ECU 32 of the vehicle control device 31 related to the third embodiment will be described with reference to the drawings.

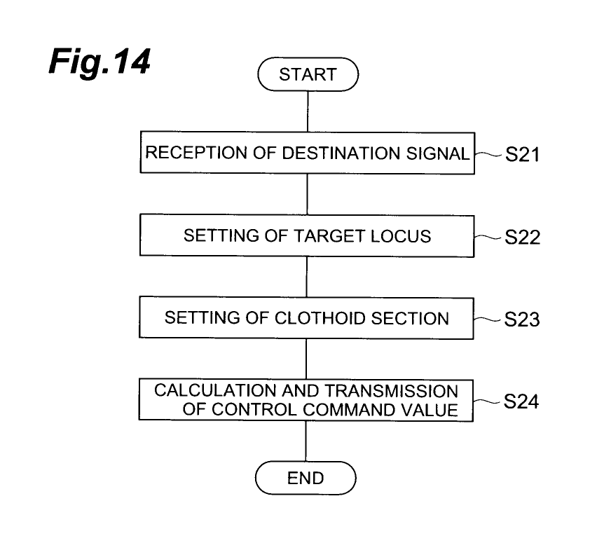

As shown in FIG. 14, first, the target trajectory setting section 11 of the ECU 32 receives a destination signal transmitted from the navigation system 3 (S21). The target trajectory setting section 11 recognizes the destination of the vehicle and the current position of the vehicle on the basis of the received destination signal and position signal. Then, the target trajectory setting section 11 sets the target trajectory from the current position of the vehicle to the destination (S22). After the target trajectory is set, the arc section setting section 23 sets, as a clothoid section, a section with the fixed curvature change rate dκ of the target trajectory (S23).

In S24, the vehicle control operation section 25 calculates a control command value on the basis of the position signal transmitted from the navigation system 3, the traveling state signal transmitted from the vehicle sensor 4, and the target trajectory. Here, the vehicle control operation section 25 calculates the tire angle command value δT in the arc section using the map for an arc section. The map for an arc section is changed according to the corresponding vehicle speed V. The vehicle control operation section 25 transmits a control command value including the tire angle command value δT to the vehicle control unit 5 as a control signal. The vehicle control unit 5 controls the vehicle according to the control signal transmitted from the vehicle control operation section 25.

According to the vehicle control device 31 related to the third embodiment described above, it becomes possible to reduce the operation amount of vehicle control in the clothoid section by performing the vehicle control using the map for a clothoid section. In addition, by improving the precision of the map for a clothoid section, it is possible to improve the reliability of vehicle control in the clothoid section. Moreover, in the vehicle control device 31, the map for a clothoid section is created by the above-described creation procedure using the maps M1 and M2 created on the basis of the results of actual vehicle tests. Accordingly, vehicle control along the target trajectory can be ensured under the conditions where the value of the slip angle β is large and the non-linearity of a tyre is strong accordingly.

While the preferred embodiments of the present invention have been described, the present invention is not limited to the embodiments. For example, the first to third embodiments may be appropriately combined, or the configurations of all embodiments may be provided together. Moreover, the operation of the tire angle command value based on the elapsed time t after a vehicle enters a target trajectory and the clothoid section is not limited to using the above-described expression (1).

In addition, the lateral force calculating section 14 related to the first embodiment is not limited to calculating the lateral force by a convergence operation. For example, the lateral force calculating section 14 may calculate the lateral force linearly from the slip angle by the conventional method. In addition, the lateral force calculating section 14 may calculate the lateral force using a map in which the slip angle and the lateral force in a vehicle are associated with each other.

### Industrial Applicability

The present invention may be used for a vehicle control device which controls a vehicle along the target trajectory.

### Reference Signs List

1, 21, 31: vehicle control device
3: navigation system
4: vehicle sensor
5: control unit
11: target trajectory setting section
12: clothoid section setting section
13: elapsed time calculating section
14: lateral force calculating section
15, 25, 34: vehicle control operation section
23: arc section setting section
24: map storage section for arc section
33: map storage section for clothoid section

1. A vehicle control device which controls a vehicle along a target trajectory, comprising: a
target trajectory setting unit that sets the target trajectory of the vehicle;
a clothoid section setting unit that sets a clothoid section with a fixed curvature change rate of the target trajectory set by the target trajectory setting unit;
an elapsed time calculating unit that calculates a time elapsed after the vehicle enters the clothoid section; and
a tire angle command value calculating unit that calculates a tire angle command value, which is used for steering control of the vehicle, on the basis of the target trajectory set by the target trajectory setting unit and the time elapsed calculated by the elapsed time calculating unit.

2. The vehicle control device according to claim 1, further comprising:
a slip angle detecting unit that detects a slip angle of the vehicle; and
a lateral force calculating unit that calculates a lateral force applied to the vehicle on the basis of the slip angle detected by the slip angle detecting unit,
wherein the lateral force calculating unit calculates the lateral force by a convergence operation using a characteristic of the lateral force with respect to the slip angle in the vehicle, and
the tire angle command value calculating unit calculates the tire angle command value on the basis of the lateral force calculated by the lateral force calculating unit.

3. The vehicle control device according to claim 1, further comprising:
a clothoid section map storage unit that stores a map for a clothoid section in which a combination of curvature and curvature change rate in the clothoid section is associated with the tire angle command value,
wherein the tire angle command value calculating unit calculates the tire angle command value using the map for a clothoid section.

4. The vehicle control device according to claim 1, further comprising:
an arc section setting unit that sets an arc section with fixed curvature of the target trajectory; and
a map storage unit for an arc section that stores a map for an arc section in which the curvature in the arc section is associated with the tire angle command value,
wherein the tire angle command value calculating unit calculates the tire angle command value using the map for an arc section.

5. The vehicle control device according to claim 1,
wherein the tire angle command value calculating unit calculates the tire angle command value using following expression (1),
$${δ}_{T} = \frac{V}{{C}_{1}} \cdot κ - \frac{V}{{C}_{1}} \cdot \frac{{C}_{2} \cdot ( 1 - {e}^{{c}_{6} \cdot t} )}{{C}_{1} - {C}_{2} \cdot {C}_{6} \cdot {e}^{{c}_{6} \cdot t}} d κ \qquad ( 1 )$$
where δT, V, κ, dκ, t, C₁, C₂, and C₆ in the expression (1) are the tire angle command value, a vehicle speed of the vehicle, curvature of the target trajectory, a curvature change rate of the target trajectory, the time elapsed, a coefficient expressed by following expression (2), a coefficient expressed by following expression (3), and a coefficient expressed by following expression (4), respectively,
$$\begin{matrix}{C}_{1} = \frac{V}{( 1 - \frac{m}{{L}^{2}} \frac{( {K}_{f} {l}_{f} - {K}_{r} {l}_{r} )}{{K}_{f} {K}_{r}} {V}^{2} ) \cdot L} & ( 2 ) \\ {C}_{2} = \frac{\begin{matrix}- ( 1 + \frac{1}{m {V}^{2}} ( {K}_{f} {l}_{f} - {K}_{r} {l}_{r} ) ) V + \\ \frac{{K}_{f}}{m V} ( 1 - \frac{m}{{L}^{2}} \frac{( {K}_{f} {l}_{f} - {K}_{r} {l}_{r} )}{{K}_{f} {K}_{r}} {V}^{2} ) \cdot L\end{matrix}}{( \frac{( {K}_{f} + {K}_{r} )}{m V} ) ( 1 - \frac{m}{{L}^{2}} \frac{( {K}_{f} {l}_{f} - {K}_{r} {l}_{r} )}{{K}_{f} {K}_{r}} {V}^{2} ) \cdot L} & ( 3 ) \\ {C}_{6} = - \frac{( {K}_{f} + {K}_{r} )}{m V} & ( 4 )\end{matrix}$$
where m, L, l_{f}, lᵣ, K_{f}, and Kᵣ in the expressions (2) to (4) are weight of the vehicle, a wheel base of the vehicle, a distance between a front axle of the vehicle and the center of gravity of the vehicle, a distance between a rear axle of the vehicle and the center of gravity of the vehicle, a lateral force of a front wheel of the vehicle, and a lateral force of a rear wheel of the vehicle, respectively.
